(19) United States
(12) Patent Application Publication
(10) Pub. No.: US 2019/0276980 A1
(43) Pub. Date: Sep. 12, 2019

(54) Coating Composition and Method

(71) Applicant: HeiQ Pty Ltd, Waurn Ponds (AU)

(72) Inventors: Murray HEIGHT, Newtown (AU); Alessandra SUTTI, Torquay (AU); Teo SLEZAK, Belmont (AU); Martina DI VENERE, Geelong (AU); Danielle BASSANESE, Belmont (AU); Marzieh PARHIZKAR, Grovedale (AU); Nathan THOMPSON, Geelong (AU); Surya SUBIANTO, Geelong (AU); Amol PATIL, Geelong (AU)

(21) Appl. No.: 16/291,724

(22) Filed: Mar. 4, 2019

(30) Foreign Application Priority Data
Mar. 6, 2018 (AU) 2018900730

(51) Int. Cl. D06M 15/21; C09D 5/24; C09D 5/26; C09D 7/61; D06M 11/79; D06M 13/46

(52) U.S. Cl. CPC D06M 15/21; C09D 5/24; C09D 5/26; D06M 2101/34; D06M 11/79; D06M 13/46; C09D 7/61

(57) ABSTRACT

The invention relates to a coating composition for fabrics containing microfibers including a polymer and pigment within the microfibers and also to a method of coating fabrics.

### FIELD

The invention relates to a coating composition comprising microfibers of particular use in preparing a breathable coating on flexible materials particularly fabrics such as textiles and leather and to a method of coating such as by screen printing of fabrics.

### BACKGROUND

Coatings for fabrics have typically been applied in the form of plastisols or water based ink coating compositions.

Plastisol compositions, commonly used in screen printing of fabrics, generally contain particles of PVC dispersed in a plasticiser. The plastisol is cured on fabrics at a temperature of between about 150° C. and 300° C. and forms an occlusive layer which is moisture impermeable. While plastisols are easy to use their use is limited to fabrics which will withstand the cure temperature and the resulting screen printed area is raised from the material and detracts from the aesthetics and feel of the printed fabric. The high temperatures required for curing can also lead to mobilisation of dyes and other substances negatively impacting print quality. The raised nature of the plastisol also results in a tendency for the coating to crack, clump or rub and perish more rapidly than desirable. The moisture barrier formed by a plastisol also limits the area and types of garment to which they can be applied.

A popular alternative to plastisols are water based coatings which cure through evaporation of water, volatile organic solvents and with heat. Water based inks are generally absorbed into fabrics rather than remaining as a surface layer and retain a better feel, breathability and consistency than plastisols.

Despite the advantages of water based coatings they are generally more difficult to cure than plastisols and require a longer cure time. The penetration of water based dyes into the fabric also often results in loss of coating into the fabric or bleeding of colour from the fabric to the surface. As a consequence the results from water based inks are generally not as sharp as plastisols. Also water based inks tend to have a much shorter shelf life than plastisols and last only about a week or so once opened.

There is a need for a coating composition and method of coating which reduces the problems associated with plastisol and water based inks.

### SUMMARY

In one aspect the invention provides a coating composition comprising:
microfibers comprising a polymer adapted to be adhesive on being subject to a temperature in the range of 80° C. to 140° C. and a pigment within the microfibers; and
a liquid carrier for the microfibers;
wherein the microfibers are present in an amount of at least 1% w/w of the coating composition, preferably at least 5% w/w of the coating composition, such as 5% to 80% w/w of the coating composition.

In a preferred embodiment the polymer is a thermoset polymer, a thermoplastic polymer or mixture.

In a further aspect the invention provides a method of coating at least part of a flexible substrate comprising applying to the substrate the coating composition and heating the coated substrate to a temperature in the range of 80° C. to 140° C.

In one set of embodiments the microfiber is present in the coating composition in an amount of at least 10% w/w, more preferably at least 15% w/w, still more preferably at least 20% w/w based on the coating composition such as 10% to 80% w/w, 15% to 80% w/w, 15% to 60% w/w, 20% to 60% w/w or 30% to 60% w/w of the coating composition.

The coating composition may be shear thinning particularly where the coating comprises a relatively high loading of the microfibers such as at least 20% w/w, such as at least 25% w/w or at least 30% w/w of the coating composition. This allows the coating composition to be used in a solid or semisolid consistency and yet be effectively applied by screen printing or doctor blading. In this embodiment the coating composition can be used as a replacement for plastisols.

One of the significant advantages of the invention over plastisol coatings is that effective coating can be provided by screen printing or other methods such as dip coating or spray application without an occlusive coating being formed. The microfiber allows good coating consistency to be provided while retaining an open porous structure on a fabric. This allows larger areas of fabric to be coated than generally acceptable for plastisols. Further the coating remains breathable and does not impact as significantly on thickness of fabrics as plastisols. This allows a more diverse range of applications not possible with plastisols such as sports clothing.

The presence of pigment within the microfiber also protects the coating from bleeding of dyes and residues from the base fabric, loss of the pigment into the base fabric with the resultant loss of pigment from the surface or the discolouration from mixing of pigment from the coating and base fabric.

The liquid carrier may be selected from the group consisting of water, C₂ to C₄ alkanols and mixtures thereof and the liquid carrier may contain a high proportion of water such as at least 80% v/v water, at least 90% v/v water, preferably water. The ability to use a high proportion of water, significantly reduces the problem of volatile organic solvents and yet is readily removed in the process in which the microfibers are heat treated.

The microfibers are preferably present as a dispersion of the solid microfibers in an aqueous liquid carrier. An aqueous dispersion of the microfibers may be stabilised with surfactants thickeners or other additives to form a storage stable suspension of microfibers.

In a preferred set of embodiments the pigment is selected from the conductive pigments, opacifying agents, fluorescent pigments and reflective agents.

The invention further provides a method of coating at least part of a flexible substrate comprising applying to the substrate the coating composition and heating the coated substrate to a temperature above the melting or setting temperature of the coating composition and in the range of 85° to 145° C.

In a particularly preferred embodiment the coating is shear thinning and is applied by screen printing.

The substrate may in one set of embodiments be a fabric comprising synthetic fibers particularly synthetic fibers comprising at least one selected from polyester, polyamide, polyolefin, multifiber yarn comprising at least one of polyester, polyamideand polyolefin fiber.

### BRIEF DESCRIPTION OF DRAWINGS

Embodiments of the invention referred to in the Examples are described with reference to the attached drawings.

In the drawings:

FIG. 1 is a micrograph of aqueous dispersion microfibers containing 60% by weight mica pigment based on the weight of polymer and prepared according to Example 1.

FIG. 2 is a micrograph of an aqueous dispersion of microfibers containing 12% by weight mica pigment based on the weight of polymer and prepared according to Example 2.

FIG. 3 is a micrograph showing a network of fibers adhered to a porous fabric, the microfibers containing 40% w/w mica based on the weight of the polymer of the microfibers, the microfibers having been deposited on the porous fabric and subject to heating at 120° C. to produce the network adhered to the fabric surface in accordance with Example 3.

FIG. 4 is a micrograph of an aqueous dispersion of microfibers containing fluorescent pigment described in Example 4.

FIG. 5 is a micrograph of isolated polymeric fibers containing titanium dioxide particulate filler in an amount of 31% w/w based on the weight of the polymer of the microfibers as described in Example 5.

FIG. 6 is a photograph of a sample of the fibers depicted in FIG. 5 as a suspension in ethanol in accordance with Example 5.

FIG. 7 is a photograph of a fabric under UV light which has been coated with a spray coating of a composition having microfibers containing fluorescent pigment in an amount of 30% w/w of the polymer of the microfibers and which has been heated at 120° C. to adhere the coating to the fabric surface in accordance with Example 6.

FIG. 8 is a micrograph of fabric fiber having a coating of microfiber containing 30% fluorescent pigment applied by screen printing in accordance with Example 7 prior to heat treatment.

FIG. 9 is a micrograph showing the fabric fibers from the fabric depicted in FIG. 8 following heat treatment to adhere the fibers to the fabric surface.

FIG. 10 is a micrograph of a plastisol provided for comparison with the micrograph of Example 9.

FIG. 11 is a micrograph showing a microfiber dispersion in which the microfibers contain a plurality of glass beads as described in Example 9

FIG. 12 is a micrograph showing a microfiber dispersion of relatively short microfibers each containing a single glass bead as described in Example 9

FIG. 13 is a micrograph of a microfiber dispersion in which the microfibers contain both glass beads and silica.

### DETAILED DESCRIPTION

The term “fiber” as used herein includes fibers of extreme or indefinite length (i.e., filaments) and fibers of short length (i.e. staple). The term “yarn” as used herein means a continuous strand of fibers.

The term “microfibers” refers to fibers having a diameter in the range of from 0.1 and 100 microns, preferably in the range of from 0.1 to 20 microns, more preferably from 0.1 to 10 microns such as 0.1 to 5 microns. The length of the microfibres may be significantly greater than 100 microns and the aspect ratio (length divided by width) is typically at least 2 and preferably at least 5 such as such as 5 to 10,000 or 10 to 5,000. In a further embodiment the aspect ratio of the fibres is relatively low such as 1.5 to 5 or 2 to 4. Such relatively low aspect ratios may be advantageous in screen printing as they minimise the retention of the fibers on the screen.

The term “fabric” as used herein includes a textile structure composed of mechanically interlocked fibers. The structure can be a nonwoven, woven, knitted, crocheted, knotted or felted fabric. The fabric in this invention is generally a woven, knitted, crocheted, knotted or felted fabric and typically woven, knitted or crocheted.

The term “multifiber yarn” as used herein means a yarn comprised of a plurality of individual fibers or strands, typically at least 20 such as at least 50 or 50 to 150 fibers. The multifiber yarn which is most significantly improved by the invention contains staple fibers such as a blend of natural staple fibers and synthetic fibers.

As used herein, the terms “polymer” and “polymeric material” generally include homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

The term “dispersion” encompasses any form of solid (solid referring to solid at room temperature of about 20° C.) dispersed in a liquid medium including, for example, latexes, emulsions, colloidal suspensions, and the like.

The term “aqueous dispersion” refers to a dispersion carrier that is primarily water. However, incidental organic solvents, such as those present in additives and commercially available components, may be present. Thus, the microfibers may be present as an aqueous dispersion at least substantially free of organic solvents. Preferably, however, “aqueous dispersion” refers to an at least 80% w/w water carrier preferably at least 90% such as at least 95% or about 100% water of the carrier component of the aqueous dispersion composition.

The term “heat-activated adhesive” as used in the present invention refers to an adhesive which exhibits adhesiveness as a result of heating. The heating is carried out, for example, at about 80° C. to 140° C. (preferably 90° C. to 130° C.).

The term “(meth)acrylic acid” is shorthand notation for methacrylic acid and/or acrylic acid. Likewise, the term “(meth)acrylate” is shorthand notation for methacrylate and/or acrylate.

Shear thinning, is described in “Dynamics of Polymeric Liquids”, Vol I; P. B. Bird, R. C. Armstrong and O. Hassayin, 1977, Wiles & Sons, N.Y. The optimum composition of the shear thinning coat layer is determined in accordance with the material of the support, the properties of the coating liquid and the movement speed of the support. For shear thinning fluid, the shear stress T˜, is related to the rate of strain, Y· ˜, as T=η Y where η is the viscosity, whose dependence is given as η=η (|Y|) where |Y· ˜| is the magnitude of the rate of strain.

The microfibers comprise pigments which interact with the electromagnetic spectrum.

The term pigment refers to a colouring matter or reflective material. The term pigment includes substances which are generally considered insoluble in the vehicle, and pigments generally have the property of light refractivity. The term pigment is to be understood here in a broad sense and includes white, black, coloured and luminous pigments. (Dyes are considered soluble and generally have only the property of light absorption.) Phosphorescent, luminescent, fluorescent, metalescent, and pearlescent materials fit within the term pigment, as used herein. The pigment is generally in particle form and should have a mean particle size between about 0.1 and about 100 microns and preferably between about 0.1 and about 50 microns. The most preferred mean particle size for pigments is about 0.2 microns to 10 microns. Examples of organic and inorganic pigments which can be used in this invention are iron blue zinc oxide, titanium dioxide, chrome yellow, carbon black, chrome orange, chrome green, zinc chromate, red lead, lethol red, the lakes, azo type toners, phthalocyanines, aluminum hydrates, lakes, iron oxide, white lead, extenders, phosphotungstic acid toners, titanium-containing pigments, sulfur-containing pigments, extenders, calcium carbonate, aluminum oxide, lithopane, ultraphone, lead chromate, cadmium sulfide, cadmium selenide, barium sulfate, azo pigments, anthraquinone and vat pigments, phthalocyanine pigments, acrylamino yellow, magnesium oxide, chrome red, antimony oxide, zinc sulfide, magnesium fluoride and ground barytes. Benzoid pigments are useful and examples are toners and lakes. Examples of benzoid toners are yellow toners, e.g., benzoid yellows and Hansa yellows; orange toners, e.g., vat orange 3; red toners, e.g., napthol reds; violet toners; blue toners; green toners; brown toners; and black toners. Examples of benzoid lakes are yellow lakes, e.g., acid yellow 2; orange lakes; red lakes; violet lakes; blue lakes; e.g., acid blue 93; green lakes; brown lakes; and black lakes, e.g., natural black 3. Metallic pigments can be used, and examples are aluminium flakes. Mixtures of pigments can be used. Pigments include mica transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air. In certain non-limiting embodiments, a photosensitive composition and/or photochromic composition, which reversibly alters its colour when exposed to one or more light sources, can be used. Photochromic and/or photosensitive compositions can be activated by exposure to radiation of a specified wavelength. When the composition becomes excited, the molecular structure is changed and the altered structure exhibits a new colour that is different from the original colour of the composition. When the exposure to radiation is removed, the photochromic and/or photosensitive composition can return to a state of rest, in which the original colour of the composition returns. In a further embodiment the pigment is a thermochromic or thermosensitive pigment. For the purpose of this invention reflective materials such as glass beads, plastic beads, which in microsphere form are considered reflective pigments.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

In one aspect the invention provides a coating composition comprising: microfibers comprising a polymer adapted to be adhesive on being subject to a temperature in the range of 80° C. to 140° C. and pigment within the microfibers; and a liquid carrier;

wherein the microfibers are present in an amount of at least 1% w/w of the coating composition preferably at least 1% w/w of the coating composition, preferably at least 5% w/w of the coating composition such as 5% to 80% w/w of the coating composition.

The microfibers comprise a polymer adapted to be adhesive on being subject to a temperature in the range of 80° C. to 140° C. The polymer in one embodiment is a thermoplastic or thermoset polymer and undergoes thermally induced setting and/or becomes thermoplastic at a temperature in the range of from 80° C. to 140° C.

The microfibers comprise a polymer adapted to be adhesive on being subject to a temperature in the range of 80° C. to 140° C. The specific chemical nature of the adhesive polymer is not narrowly critical and a person of skill in the art will readily be able to select adhesive for use in the process of the invention having regard to the formulation requirements and nature of the fabric substrate to be coated. Specific examples of chemical classes of adhesive include ethylene-vinyl acetate (EVA) copolymers; ethylene-(meth)acrylate copolymers including copolymers of ethylene and (C₁ to C₄ alkyl) (meth)acrylate such as ethylene-butyl (meth)acrylate, ethylene-ethyl (meth)acrylate, and ethylene-methyl (meth)acrylate copolymers (ethylene n-butyl acrylate (EnBA) is a preferred copolymer); ethylene-(meth)acrylic acid (EAA) and ethylene-ethyl acetate (EEA); polyolefins (PO) (polyethylene (usually LDPE but also HDPE (HDPE has higher melting point and better temperature resistance), atactic polypropylene (PP or APP); polybutene-1, oxidized polyethylene, amorphous polyolefin (APO/APAO) polymers; polyamides, polyesters; thermoplastic polyurethane (TPU); polyurethanes (PUR), or reactive urethanes; styrene block copolymers (SBC), also called styrene copolymer adhesives and rubber-based adhesives. adhesives may in addition to the primary polymer contain tackifiers, waxes, mixtures of two or more types of adhesive and mixtures of one or more adhesives with other additives to modify the melting point and/or the bonding properties of the adhesive. In general the preferred class of adhesives are the ethylene (meth)acrylate copolymers and in particular copolymers of ethylene and acrylic and/or methacrylic acid and ionomers of such copolymers.

The adhesive polymer in one set of embodiments is a copolymer of ethylene and at least one of an acrylate and methacrylate monomer which may, for example be acrylic acid, methacrylic acid, (C₁ to C₄ alkyl) acrylate, (C₁ to C₄ alkyl) methacrylate. The polymer acid groups may be at least partly neutralised by ammonia or an amine, particularly a tertiary amine such as N,N-dimethylethanolamine. The total content of acrylate and methacrylate monomers is typically from 5% to 40% by weight of the copolymer.

The microfibers comprising adhesive polymers may be copolymers of ethylene and acrylic acid optionally at least partly neutralised with a nitrogen base such as ammonia or amines, particularly tertiary amines including N,N-di(C₁ to C₄ alkyl) C₁ to C₄ alkanolamines such as N,N-dimethylethanolamine. These adhesives are preferred due to the melting profile which may be provided and the resilience and effective bonding provided by the incorporation of particles of this adhesive from an aqueous dispersion. Suitable example of such copolymers are commercially available under a range of trade names including NUCREL® (DuPont Packaging & Industrial Polymers), PRIMACOR® (Dow Chemical or SK Global Chemical Co., LTD) LUGALVAN® DC and CARBOSET® 560. Copolymers of ethylene and acrylic acid often referred to as Poly(ethylene-co-acrylic acid) or PEAA which may be in the form of ionomers are typically synthesized via the high pressure, free radical copolymerization of ethylene and acrylic acid. This process results in a highly branched polymer with random placement of the constituent monomers along the backbone. For example, one particularly useful adhesive is an ethylene acrylic acid copolymer having an acrylic acid content of from 5% to 40% w/w of the copolymer, preferably from 5°/0w/w to 30% w/w of the polymer such as from 5% to 25% w/w of the copolymer. We have found that a content of about 20% w/w of the ethylene acrylic acid is particularly useful in the present invention. For 5 weight percent PEAA copolymers, the melting temperature is about 100° C. Increasing the acid content to 20 wt % decreases the melting temperature to about 75° C. to about 80° C.

Polymers of ethylene and (meth)acrylic acid may be in the form of ionomers formed with a nitrogen base such as ammonia or an amine, particularly a tertiary amine such as N,N-dimethylethanolamine. The presence of the nitrogen base provides a self-dispersing polymer which avoids the use of additives to form or stabilise the dispersion in an aqueous medium. LUGALVAN® DC and CARBOSET® 560 products are examples of such dispersions.

The microfibers may be contacted with at least one surface stabilizer to provide a stable dispersion composition in which the surface stabilizer is adsorbed to the surface of the microfiber particles. The surface stabilizer can be contacted with the microfiber particles for a time and under conditions sufficient to provide the surface stabilisation during formation of the microfiber, with isolated particles or during preparation of the coating composition. The surface stabiliser is typically a quaternary ammonium surfactant, an organic acid salt, a sulfonate surfactant or polyether (e.g. polyethylene glycol) surfactant such as an ethoxylated hydrocarbyl alcohol.

In a further embodiment the microfibers may be prepared with incorporation of at least one cationic surface stabilizer into the polymer composition. The surfactant may, for example, be blended with the polymer prior fiber formation or during fiber formation. In one embodiment the surfactant is incorporated into a medium in which the fibers are formed.

In a preferred embodiment the microfibers comprise adhesive polymers comprising (meth)acrylic monomers, such as copolymers of ethylene and (meth)acrylic acid such as the copolymers having an acrylic acid content of from 5% to 40% w/w of the copolymer, preferably from 5% w/w to 30% w/w of the polymer such as from 5% to 25% w/w of the copolymer, and are treated with a cationic surfactant, particularly a quaternary ammonium surfactant, to provide surfactant associated with the surface of the fibers. This embodiment allows the microfibers to be more stable as an aqueous dispersion with minimal use of additional surfactant or indeed no use of additional surfactant. Preferably the surfactant will be a C₁₀₋₄₀ surfactant, that is a surfactant comprising at least one (preferably one) C₁₀₋₂₀ alkyl group. Generally the surfactant will be present in the microfiber composition in an amount of at least 0.001% by weight, preferably at least 0.005% by weight or even at least 0.01% by weight. Generally, the surfactant will be present in amounts no greater than 5%, preferably no greater than 3% and more preferably no greater than 2.5% by weight. Preferred quaternary ammonium surfactants include cetyltrimethylammonium bromide, or the chloride salt or a mixture thereof.

The microfiber may comprise a single polymer which is adhesive on being subject to a temperature in the range of 80° C. to 140° C. or may comprise a plurality of such polymers which together are adhesive on being subject to a temperature in the range of 80° C. to 140° C. provide . Further the microfibers may comprise a blend of polymer some of which are adhesive and some of which are not provided the microfiber composition is adapted to become adhesive as a result of heating the microfiber to a temperature of 80° C. to 140° C.

Typically the polymer component of the microfibers will comprise at least 20% w/w, preferably at least 50% w/w such as at least 60% w/w, at least 70% w/w, at least 80% w/w or at least 90% w/w polymer components which are thermomelting or thermoplastic at a temperature of 80° C. to 140° C. In one set of embodiments the polymer component of the microfiber is thermoplastic or thermosetting at a temperature of 80° C. to 140° C.

In a particularly preferred set of embodiments the microfibers comprise at least 20% w/w, preferably at least 50% w/w such as at least 60% w/w, at least 70% w/w, at least 80% w/w or at least 90% w/w polymer components which are thermoplastic at a temperature of 80° C. to 140° C. In one set of embodiments the polymer component of the microfiber is thermoplastic at a temperature of 80° C. to 140° C.

In a particularly preferred set of embodiments the microfibers comprise at least 20°/0w/w, preferably at least 50% w/w such as at least 60% w/w, at least 70% w/w, at least 80% w/w or at least 90% w/w polymer components are thermoplastic at a temperature of 80° C. to 140° C. selected from copolymers of ethylene and acrylic acid optionally at least partly neutralised with a nitrogen base such as ammonia or amines, particularly tertiary amines including N,N-di(C₁ to C₄ alkyl) C₁ to C₄ alkanolamines such as N,N-dimethylethanolamine. These adhesives are preferred due to the melting profile which may be provided and the resilience and effective bonding provided by the incorporation of particles of this adhesive from an aqueous dispersion. Suitable example of such copolymers are commercially available under a range of trade names including NUCREL® (DuPont Packaging & Industrial Polymers), PRIMACOR° (Dow Chemical or SK Global Chemical Co., LTD) LUGALVAN® DC and CARBOSET° 560.

The material may interact with the visible spectrum and exhibit colour or may merely interact with the infrared or UV wavelength of the spectrum so as to be visible only when subject to specific wavelengths.

The microfibers contain a pigment. A wide range of pigments may be used in the coating composition and are generally compatible with the polymer component of the microfiber.

In one set of embodiments the pigment is a reflective pigment Some examples of reflective pigment and/or retroreflective pigments include, for example, titanium powder (e.g., titanium dioxide), mica, reflective flakes, pearlescent pigments, nacreous pigments, and metal powders (e.g., aluminium powder, zinc powder, titanium oxide powder, zirconium oxide powder and silver dust powder), glass beads or microspheres, and metal coated glass beads or microspheres. Nacreous pigments are well known in the art, with several manufacturers now supplying synthetic pigments. The nacreous pigment flakes used in this invention are typically at least transluscent and are preferably substantially transparent. Suitable materials include BiOCl₂, hexagonal PbCO₃, and guanine from fish scales. In general, such pigment flakes are available in several grades and carefully controlled size ranges.

The pigment may be in the form of micro-beads of glass or silica which may be partially coated with a reflective film. The beads have a size distribution within the range of 10 microns to 40 microns such as 30 microns to 40 microns, there being substantially no beads present with larger or smaller diameters. The invention also provides articles typically fabric articles such as items of clothing or accessories which are at least partially coated with a retro-reflective coating according to the first aspect of the invention.

The purpose of retro-reflective coatings is to render articles, such as items of clothing, or accessories, visible in darkness or low light conditions by reflecting incident light from an illuminating source, such as vehicle headlamps, or a hand torch, substantially back towards the direction of incidence.

The pigment may be present in a range of amounts depending on the type of pigment and the required function. Typically the amount of pigment is in the range of from 5% w/w to 250% w/w based on the weight of the polymer component of the microfibers. Particularly pigment loadings of 10% w/w to 100% w/w based on the weight of the polymer component are preferred such as from 20% w/w to 80% w/w based on the weight of the polymer component of the microfibers. The microfibers may contain additional components aside from the polymer and pigment components such as auxiliaries including processing aids. In genteral the auxiliary components will be present in an amount of no more than 30% w/w based on the polymer component.

The coating composition in one set of embodiments comprises:
1% w/w to 60% w/w (preferably 5%w/w to 60% w/w, more preferably 15% w/w to 60% w/w) of microfibers of composition including:
20% w/w to 90w/w of a thermoplastic polymer having a melting point in the range of from 60° C. to 140° C.;
10% w/w to 50% w/w of pigment; and
40% w/w to 99% w/w (preferably 40% w/w to 95% w/w, more preferably 40% w/w to 85% w/w of carrier composition comprising water, C₂ to C₄ alkanol or mixture thereof and optionally further auxiliaries such as at least one selected from the group consisting of surfactants, rheology modifier, binder, pigments and fillers. In one set of embodiments the auxiliaries constitute no more than 10% w/w (preferably no more than 5% w/w) of the carrier composition.

In a further aspect there is provided a fabric having a coating of a composition comprising the microfibers hereinbefore described which have been heated to a temperature of 80° C. to 140° C. to produce a network of microfibers adhered to the surface of the fabric.

A method of coating at least part of a flexible substrate is also provided comprising applying to the substrate a coating composition as herein described and heating the coated substrate to a temperature in the range of 80° C. to 140° C.

The microfibers comprise a thermoplastic polymer having a melting point in the range of from 80° C. to 140° C. and the coating composition is cured on the fabric by subjecting the coated fabric to a temperature in the range of from 100° C. to 140° C.

Plastisols are generally required to be cured at a temperature of about 160° C. which temperature leads to the degradation of many fabrics such as ceryain polyolefin fibres and certain polyester fibres. The invention coating composition can be cured at much lower temperature such as 80° C. to 140° C. and typically at about 120° C. which allow curing on fabrics containing fibres which are not previously able to be effectively screen printed with plastisols or would be compromised by the curing temperature required by plastisols. For example the fabric may be synthetic fabric such as fabric including synthetic polymers such as polyolefins and polyesters.

The coating composition may be applied to the fabric using a range of methods including spray application, roller coating, dip coating, padding and screen printing. The solids content of the coating composition. As previously explained the shear thinning properties of the composition are a specific advantage for coating by screen printing.

In one set of embodiments the fabric comprises synthetic fibers selected from polyester, polyolefin, polyamide and multifiber yarn comprising at least one of polyester, polyamide and polyolefin fibers.

The coating composition may be shear thinning particularly where the coating comprises a relatively high loading of the microfibers such as at least 20% w/w, such as at least 25% w/w or at least 30% w/w of the coating composition. This allows the coating composition to be used in a solid or semisolid consistency and yet be effectively applied by screen printing or doctor blading. In this embodiment the coating composition can be used as a replacement for plastisols.

A process which may be used in forming suitable microfibers is described in International Publication WO2013/056312 the contents of which are herein incorporated by reference.

The process for the preparation of polymer microfibers containing pigment particles may include the steps of:
(a) introducing a stream of fiber forming liquid containing the polymer and pigment particles dispersed in the polymer into a dispersion medium;
(b) forming a filament from the stream of fiber forming liquid in the dispersion medium; and
(c) shearing the filament under conditions providing fragmentation of the filament and formation of the microfibers containing pigment particles.

The fibre-forming liquid may be the above described polymer in molten form. The fiber-forming liquid in a preferred embodiment is the polymer composition in a molten state. One skilled in the art would understand that a molten polymer composition may be formed when a fibre-forming substance such as a polymer is heated above its melting temperature. In some embodiments the molten liquid includes at least one polymer such as described above in a molten state. In other embodiments the molten liquid includes at least one polymer precursor in a molten state. In some embodiments the molten liquid may include a blend of two or more fibre-forming substances, such as a blend of two or more polymers, a blend of two or more polymer precursors or a blend of a polymer and a polymer precursor, in a molten state.

In one set of embodiments the polymer composition for forming the microfibers is thermoplastic and the microfibers are formed by a process comprising:
blending the pigment with the polymer in molten to provide a dispersion of the pigment in the molten polymer; and
injecting a melt of the polymer containing dispersed pigment into a liquid, preferably an oil such as a paraffin oil or vegetable oil to form a filament and subjecting the filament to shear to fragment the filament and form microfibers comprising pigment. In this embodiment when the liquid is an oil the microfibers may be isolated from the dispersion medium and suspended in the carrier liquid such as an aqueous carrier liquid to form an aqueous suspension of the microfibres.

Additives may be present in the dispersion medium, in the microfiber composition or both the dispersion medium and microfiber combination to stabilise the dispersion. Further additives such as surfactants dispersants, thickeners or mixtures may be present in the liquid carrier for the microfibers to assist in application or compatibility with the substrate or to provide additional treatment to confer one or more other desirable properties to the substrate. Further examples of such additives include antioxidants, weather stabilizers, light stabilizers, antiblocking agents, lubricants, nucleating agents, pigments, softeners, hydrophilizing agents, auxiliaries, water repellents, fillers, antibacterial agents and flame retardants. These additives may be added as a component of a dispersion of microfibers or may be applied to the substrate as a separate step before during or after application of a dispersion of microfibers. In one embodiment described above the additive includes surfactant such as a quaternary ammonium surfactant which may, for example be mixed with the polymer in melt form prior to formation of the microfiber or with the medium into which the microfiber is formed.

The invention will now be described with reference to the following examples. It is to be understood that the examples are provided by way of illustration of the invention and that they are in no way limiting to the scope of the invention.

In the Examples, the term “% w” refers to percent by weight.

### EXAMPLES

### Example 1

### PEAA Microfibers with Mica 60%

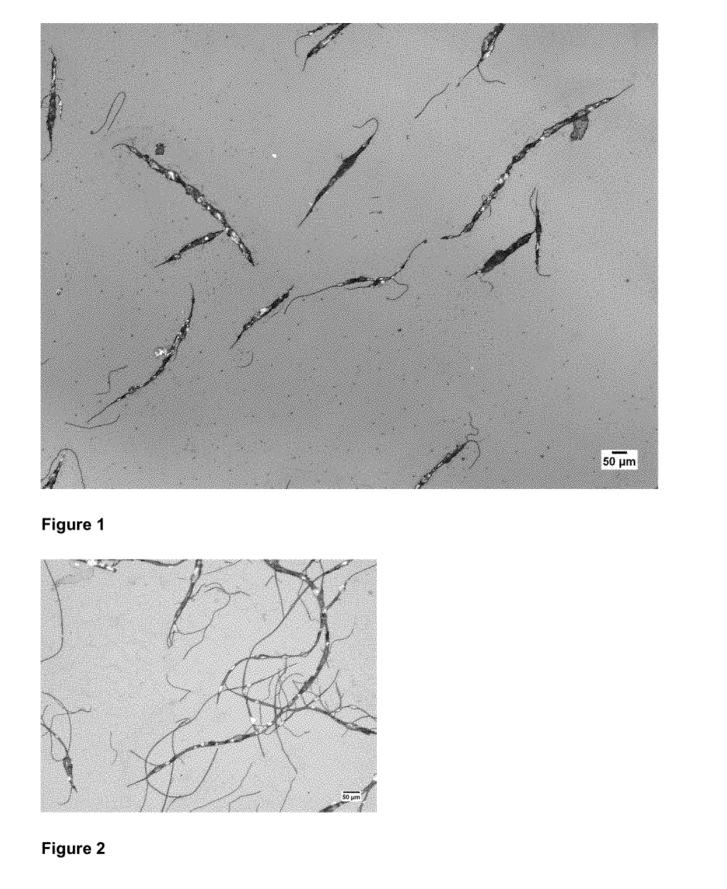

Poly(ethylene-co-acrylic acid) (PEAA) microfibers containing mica pigments in a 60% w ratio to the polymer were prepared by injecting an aqueous 16.5% w PEAA dispersion containing mica pigments (white lustre mica, Justpigments.com) into 1-butanol at room temperature. The procedure used is described in International Patent Publication WO2013/056312. The resulting dispersion of microfibers is shown in FIG. 1.

Preparation of Poly(ethylene-co-acrylic acid) (PEAA) Fibers

A 20% wt/vol solution of poly(ethylene-co-acrylic acid) (PEAA) (DowChemical, Primacor° 59901) was prepared in diluted ammonia (9% ammonia in water), stirring overnight at 95° C. This solution was then diluted with pH 12 aqueous ammonia, to prepare solutions of varying polymer concentration. 1-butanol was chosen as the dispersing solvent (250 ml). A high speed mixer (T50 UltraTurrax—IKA) equipped with high shear impeller was used in the procedure. The stirring head was inserted in a beaker of similar diameter. The dispersing solvent was first introduced in the beaker, the stirring was started and 3 ml of the polymer solution was then quickly injected in the gap between the mixer's head and the wall of the beaker by using a 3 mL syringe with a 27 G needle, injection speed: 20 mL/min. Stirring was maintained for a certain time then stopped. The fibers thus obtained are dispersed in an aqueous medium to form an aqueous dispersion of the microfibers.

### Example 2

### PEAA Microfibers with Mica 12%

Poly(ethylene-co-acrylic acid) (PEAA) microfibers containing mica pigments in a 12% wt ratio to the polymer were prepared by injecting an aqueous 16.5% wt PEAA dispersion containing mica pigments (white lustre mica, Justpigments.com) into 1-butanol at room temperature. The microfiber dispersion is depicted in FIG. 2.

### Example 3

### PEAA Microfibers with Mica 40% w and Deposited on Fabric (Porous Structure Observed)

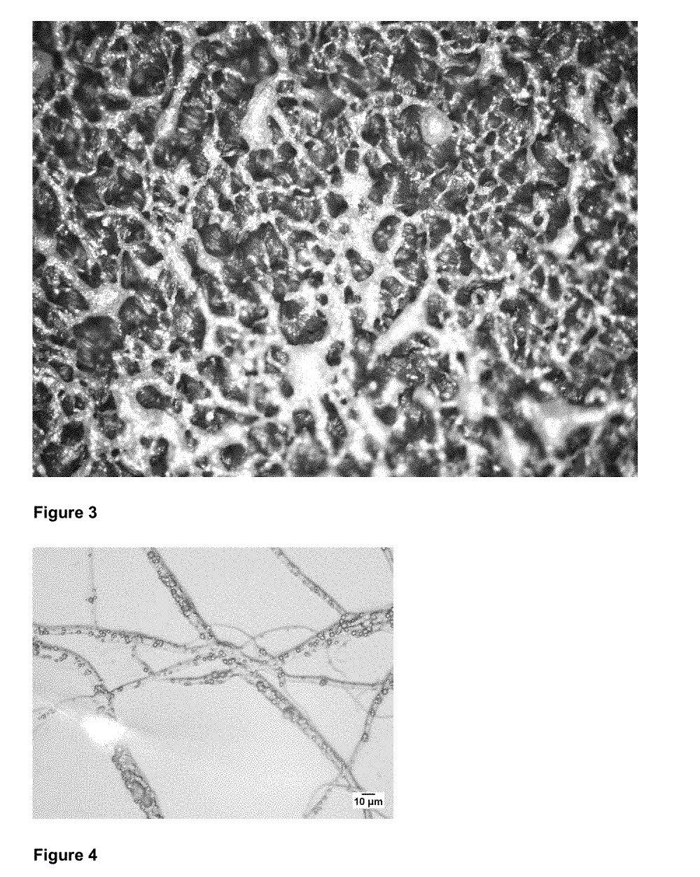

Poly(ethylene-co-acrylic acid) (PEAA) microfibers containing mica pigments in a 40% w ratio to the polymer were prepared by injecting an aqueous 16.5% w PEAA dispersion containing mica pigments (white pearl mica, Justpigments.com) into 1-butanol at room temperature. A 1-2% w suspension of the pigment-containing fibers were deposited onto a fabric (polyamide-elastane, woven) by screen printing. The coated fabric was heat treated in an oven at 120° C. The network of mica-containing polymer deposited on the fabric is visible in the optical microscope image of FIG. 3, which also shows clearly the open pores of the fabric.

### Example 4

### PEAA Microfibers with Fluorescent Pigment, Heat Treated

Poly(ethylene-co-acrylic acid) microfibers containing fluorescent pigments (fluorescent polyester resin, Justpigments.com) in concentration between 6% w and 30% w of weight of polymer, were prepared by injecting an aqueous 16.5% w PEAA dispersion containing fluorescent pigments into 1-butanol at room temperature (optical microscope image shown in FIG. 4). A 1-2% w suspension of the pigment-containing fibers were deposited onto a fabric (polyamide-elastane, woven) by screen printing, drop casting, spraying and padding. The coated fabrics were heat treated in a stenter oven at 120° C. to cause melting of the fibers and adhesion to the fabric.

### Example 5

### PEAA Microfibers with TiO₂ 31%, Screen Printing With and Without Additives

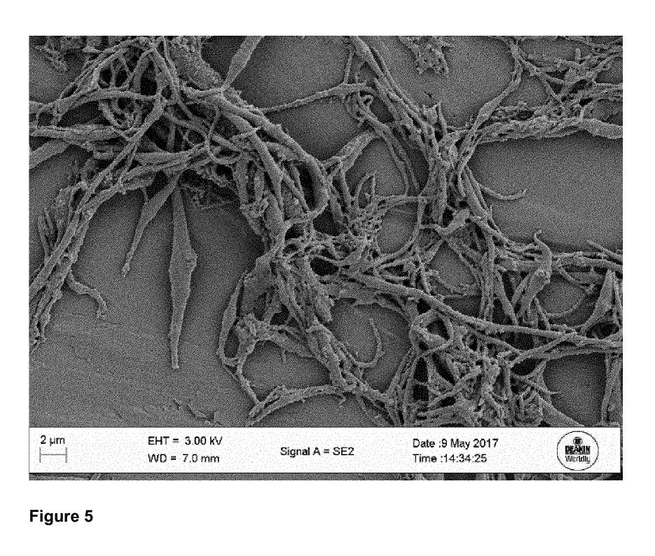

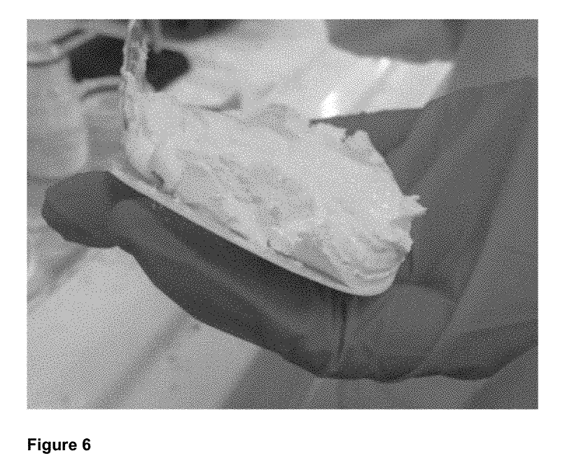

In another example, PEAA dispersions (16.5% w) were loaded with titanium dioxide powders (Tronox CR-470—TRONOX® 470 is a rutile titanium dioxide pigment consisting of about 97% TiO₂ providing bright white optical properties.), up to a weight ratio of 31% to the polymer. Fibers were produced using a recirculation mode on a single cell device, as in International patent publication WO2014/134668 (“An Apparatus for Producing Nanobodies”), using a polymer injection rate of 110 mL/hr, and 4-10° C. 1-butanol (temperature measured at the start of the process—temperature at the end of the process was found to be ˜30° C.). 20 mL of PEAA dispersion containing Tronox® CR-470 was dispersed into 400 mL of 1-butanol. The fiber suspension was filtered under pressure and 1-butanol was substituted by ethanol for processing. A 28% w slurry was collected and used for screen printing. An optical micrograph of the microfibers collected from is shown in FIG. 5 and FIG. 6 shows a photograph of the 28% w/w slurry of PEAA fibers containing the TiO₂ in ethanol.

The slurry was diluted to ˜22% w and screen printed without modification or alternatively mixed with viscosity modifiers as per Table 1. About 0.5 g of fiber slurry was mixed with different amounts of the various components, according to the table below. The paste was mixed for about 30-45 s in a small weigh-boat using a spatula. The appearance of the resulting paste was assessed immediately after.

Screen printing was performed within 5 minutes from preparing the SPF formulations, which was kept covered with Parafilm during screen preparation. An approximately 3 gram portion of paste was deposited onto the screen and this was applied to the screen by hand, onto woven polyester fabric substrate.

The slurry was diluted to ˜22% w and screen printed without modification or alternatively mixed with viscosity modifiers as per Table 1. About 0.5 g of fiber slurry was mixed with different amounts of the various components, according to the table below. The paste was mixed for about 30-45 s in a small weigh-boat using a spatula. The appearance of the resulting paste was assessed immediately after.

Screen printing was performed within 5 minutes from preparing the SPF formulations, which was kept covered with Parafilm during screen preparation. An approximately 3 gram portion of paste was deposited onto the screen and this was applied to the screen by hand, onto woven polyester fabric substrate.

TABLE 1
Compositions used for printing.

| | | A: FIXAMIN | B: FIXAMIN | C: FIXAMIN | | | |
|---|---|---|---|---|---|---|---|
| | | CPT1 (20G) | CPT1 (10G) | CPT1 (15G) | | | |
| | SPF | METHOCELL | METHOCELL | METHOCELL | | | |
| | 21.98% W IN | 1% W/V-O-S | 1% W/V-O-S | 1% W/V-O-S | | | AMOUNTS FOR |
| | ETHANOL | (10G) | (20G) | (15G) | GLYCEROL | WATER | SCREEN PRINTING |
| # | g | g | g | g | g | g | g |
| 0.1A | 0.5 | 0.1 | | | | | 3 g fibers, 0.6 g mix |
| 0.2A | 0.5 | 0.2 | | | | | N/A |
| 0.3A | 0.5 | 0.3 | | | | | N/A |
| 0.1B | 0.5 | | 0.1 | | | | N/A |
| 0.2B | 0.5 | | 0.2 | | | | 3 g fibers, 1.2 gmix |
| 0.3B | 0.5 | | 0.3 | | | | |
| 0.1C | 0.5 | | | 0.1 | | | 3 g fibers, 0.6 g mix |
| 0.2C | 0.5 | | | 0.2 | | | 3 g fibers, 1.2 gmix |
| 0.3C | 0.5 | | | 0.3 | | | N/A |
| 0.1C_0.125G | 0.5 | | | 0.1 | 0.125 | | N/A |
| 0.1A_0.125G | 0.5 | 0.1 | | | 0.125 | | 3 g fibers, |
| | | | | | | | 0.742 gmix |
| 0.1A_0.042G | | | | | | | 3 g fibers, 0.6 g |
| | | | | | | | mix, 0.250 g |
| | | | | | | | glycerol |
| 0.1B_0.042G | 3 | | 0.6 | | | 0.25 | 3 g fibers, 0.6 g |
| | | | | | | | mix B, 0.250 g |
| | | | | | | | glycerol |
| 3PEA A_0.6W | 3 | | | | | 0.6 | N/A |
| 28% SPF | 3 | | | | | | 3 g fibers |
| 3GPE AA- | 3 | | | | | 0.3 | 3 g fibers + |
| 0.3GW | | | | | | | 0.3 g water |

### Example 6

### PEAA Microfibers with Fluorescent Pigment 30%, Sprayed

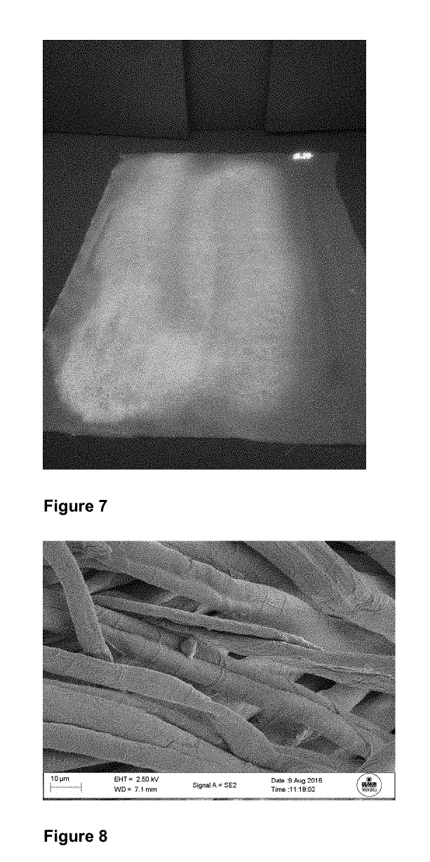

Microfibers were prepared using green pigments (Just pigment) with a weight ratio of 30% to the weight of polymer, and these were sprayed onto a woven polyester fabric. Treatment at 120° C. for 3 minutes in a stenter oven followed. FIG. 7 shows the fluorescence was retained when fabric was illuminated using ultraviolet light (365 nm wavelength).

### Example 7

### PEAA Microfibers with Fluorescent Pigment 30%, Screen Printing with Surfactant, Heat Treatment Comparison Plastisol.

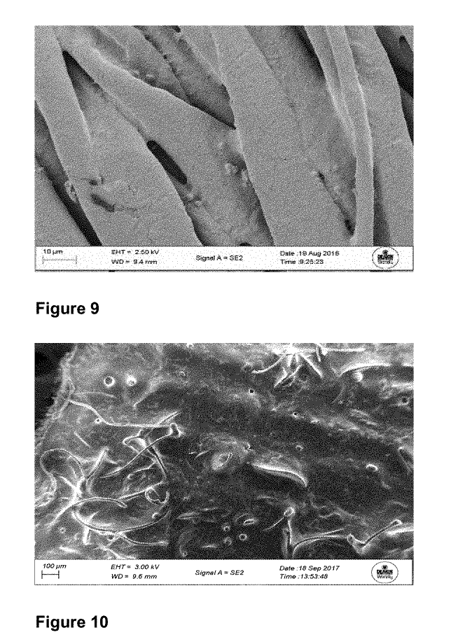

Fibers were concentrated in ethanol and rinsed with a 4.2% solution of cetyltrimethylammonium chloride in water, such that the fibers would become coated with surfactant. The suspension was concentrated to ˜20% w/w, and used to perform screen printing on a woven cotton fabric. The electron micrographs in FIGS. 8 and 9 show the fibers deposited on the cotton fabric through screen printing after air drying (FIGS. 8) and the same sample upon exposure to heat treatment (FIG. 9). PEAA is observed to melt onto the cotton fibers, revealing the carried pigments (FIG. 9).

In the same example, Plastisol was used to coat a polyester fabric (third row). The coating shows low porosity as shown in FIG. 10.

### Example 8

### PEAA Microfibers with Fluorescent Pigment 15%, Air Permeability Comparison with Other Coatings

PEAA microfibers containing green fluorescent pigment (Justpigments.com) were prepared as in the previous experiments using a 15% w ratio of the pigment to the polymer during fiber manufacture. The microfibers were washed in ethanol and used as a ˜25% w slurry in ethanol. The fibers were applied to fabrics by screen printing as shown in Table 2.

TABLE 2

| | | | | | | | Air | |
|---|---|---|---|---|---|---|---|---|
| Sample | | | Mass pre | Mass post | Curing | Curing | permeability | |
| number | Sample description | Fabric | print | print | temp | time | (cm3/cm2/s) | STDev |
| EA1 | Plastisol | PES woven | 3.148 | 4.162 | 160° C. | 3 min | 0.17 | 0.04 |
| EA3 | Plastisol | PES woven | 3.293 | 4.600 | 160° C. | 3 min | 0.10 | 0.00 |
| EA4 | Plastisol | PES woven | 3.452 | 4.474 | 160° C. | 3 min | 0.23 | 0.11 |
| EA8 | Plastisol (black ink) | PES woven | 3.697 | 4.107 | 160° C. | 3 min | 0.10 | 0.03 |
| EA9 | Plastisol (black ink) | PES woven | 3.592 | 4.062 | 160° C. | 3 min | 0.10 | 0.04 |
| EA10 | Plastisol (black ink) | PES woven | 3.495 | 3.912 | 160° C. | 3 min | 0.09 | 0.01 |
| EA20 | PEAA green | PES woven | 2.987 | 3.049 | 120° C. | 3 min | 19.87 | 0.31 |
| EA21 | PEAA green | PES woven | 3.656 | 3.719 | 120° C. | 3 min | 15.87 | 1.21 |
| EA22 | PEAA green | PES woven | 3.522 | 3.567 | 120° C. | 3 min | 19.53 | 0.91 |
| EA23 | PEAA green | PES woven | 3.715 | 3.759 | 120° C. | 3 min | 15.60 | 0.79 |
| EA24 | Permaset binder + pink pigment | PES woven | 3.716 | 3.784 | 160° C. | 3 min | 10.93 | 1.44 |
| EA25 | Permaset binder + pink pigment | PES woven | 3.121 | 3.181 | 160° C. | 3 min | 7.24 | 0.69 |
| EA26 | Permaset binder + pink pigment | PES woven | 3.535 | 3.575 | 160° C. | 3 min | 12.50 | 1.13 |
| BLANK | Blank | — | | | | | 5.13 | 0.2 |
| EB21 | PEAA green | PP woven | 7.310 | 7.425 | 120° C. | 3 min | 5.09 | 0.27 |
| EB22 | Permaset binder + pink pigment | PP woven | 7.562 | 7.593 | 120° C. | 8 min | 3.16 | 0.18 |
| EB23 | Permaset binder + pink pigment | PP woven | 7.520 | 7.599 | 120° C. | 8 min | 3.42 | 0.13 |
| EB24 | Permaset binder + pink pigment | PP woven | 7.626 | 7.709 | 120° C. | 8 min | 3.13 | 0.20 |
| EC1 | Plastisol | PES woven | 2.736 | 3.826 | 160° C. | 3 min | 0.27 | 0.04 |
| EC2 | Plastisol | PES woven | 2.990 | 4.001 | 160° C. | 3 min | 0.31 | 0.01 |
| EC3 | Plastisol | PES woven | 2.961 | 4.220 | 160° C. | 3 min | 0.30 | 0.02 |
| EC4 | Plastisol | PES woven | 2.791 | 4.080 | 160° C. | 3 min | 0.27 | 0.01 |
| EC7 | Plastisol (white ink) | PES woven | 2.665 | 3.448 | 160° C. | 3 min | 0.33 | 0.02 |
| EC8 | Plastisol (white ink) | PES woven | 3.255 | 4.146 | 160° C. | 3 min | 0.23 | 0.01 |
| EC9 | Plastisol (white ink) | PES woven | 3.148 | 3.992 | 160° C. | 3 min | 0.26 | 0.02 |
| EC10 | Permaset yellow | PES woven | 3.324 | 3.364 | 160° C. | 3 min | 0.41 | 0.04 |
| EC11 | Permaset yellow | PES woven | 3.027 | 3.068 | 160° C. | 3 min | 0.30 | 0.02 |
| EC12 | Permaset yellow | PES woven | 3.143 | 3.187 | 160° C. | 3 min | 0.36 | 0.04 |
| EC20 | PEAA green (TS17.09.PEAA.FG2.5) | PES woven | 5.043 | 5.138 | 120° C. | 3 min | 2.46 | 0.08 |
| EC21 | PEAA green (TS17.09.PEAA.FG2.5) | PES woven | 5.000 | 5.050 | 120° C. | 3 min | 2.33 | 0.22 |
| EC22 | Permaset binder + pink pigment | PES woven | 4.965 | 5.097 | 160° C. | 3 min | 0.62 | 0.09 |
| EC23 | Permaset binder + pink pigment | PES woven | 4.550 | 4.549 | 160° C. | 3 min | 0.54 | 0.02 |
| EC24 | Permaset binder + pink pigment | PES woven | 5.005 | 5.051 | 160° C. | 3 min | 0.49 | 0.01 |
| ED1 | Plastisol | PES/CO | 1.187 | 2.111 | 160° C. | 3 min | 0.06 | 0.01 |
| ED2 | Plastisol | PES/CO | 1.182 | 2.130 | 160° C. | 3 min | 0.23 | 0.23 |
| ED3 | Plastisol | PES/CO | 1.220 | 2.039 | 160° C. | 3 min | 0.07 | 0.01 |
| ED8 | Plastisol (white ink) | PES/CO | 1.260 | 1.964 | 160° C. | 3 min | 0.09 | 0.01 |
| ED9 | Plastisol (white ink) | PES/CO | 1.251 | 1.930 | 160° C. | 3 min | 0.13 | 0.02 |
| EP10 | Plastisol (white ink) | PES/CO | 1.318 | 2.013 | 160° C. | 3 min | 0.11 | 0.04 |
| ED11 | Permaset yellow | PES/CO | 1.245 | 1.286 | 160° C. | 3 min | 29.63 | 2.01 |
| ED20 | PEAA green (TS17.09.PEAA.FG2.5) | PES/CO | 2.005 | 2.069 | 120° C. | 3 min | 28.70 | 3.65 |
| ED21 | PEAA green (TS17.09.PEAA.FG2.5) | PES/CO | 2.105 | 3.168 | 120° C. | 3 min | 24.10 | 1.42 |
| ED22 | Permaset binder + pink pigment | PES/CO | 1.972 | 2.048 | 160° C. | 3 min | 22.40 | 2.00 |
| ED23 | Permaset binder + pink pigment | PES/CO | 2.013 | 2.064 | 160° C. | 3 min | 21.87 | 1.75 |
| ED24 | Permaset binder + pink pigment | PES/CO | 1.926 | 1.983 | 160° C. | 3 min | 21.47 | 1.22 |

### Example 9

### PEAA Microfibers with Glass Microbeads 30% approx.

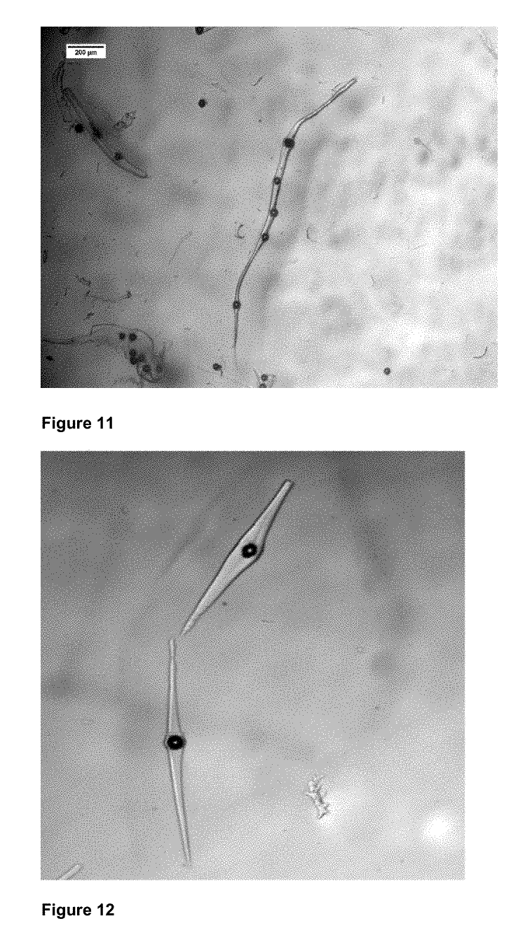

PEAA microfibers containing glass beads were produced by injecting molten PEAA containing a dispersion of the microbeads into oil, using a high-shear mixer setup to provide shear for filament formation and fragmentation. In the micrograph images of FIG. 11 and FIG. 12 it can be observed that glass beads are readily incorporated into the microfibers. In FIG. 11 the microspheres contain a plurality of glass microspheres and in FIG. 12 the microfibers each contain a single microsphere.

### Example 10

### PEAA Microfibers with Glass Microbeads 30% approx. and Mica approx. 10-30%.

PEAA microfibers containing a combination of glass beads and mica powders were produced by injecting molten PEAA containing the dispersed microbeads and mica into oil, using a high-shear mixer setup to provide shear for filament formation and fragmentation

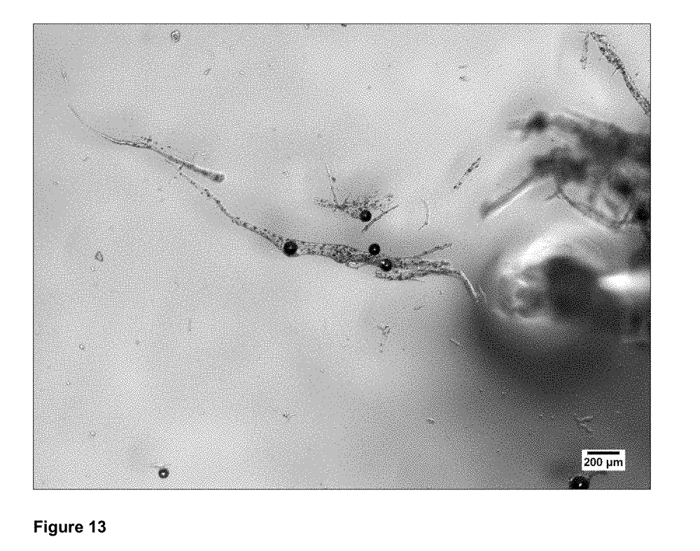

A micrograph of a dispersion of microfibers containing both glass beads and mica is FIG. 13 of the attached drawings.

1. A coating composition comprising:
microfibers comprising a polymer adapted to be adhesive on being subject to a temperature in the range of 80° C. to 140° C. and pigment within the microfibers; and
a liquid carrier;
wherein the microfibers are present in an amount of at least 1% w/w of the coating composition.

2. The coating composition of claim 1, wherein the polymer comprises a thermoset polymer, thermoplastic polymer or mixture thereof.

3. The coating composition of claim 1, wherein the microfibers are present in an amount of at least 10%.

4. The coating composition of claim 1, wherein the coating composition is shear thinning.

5. The coating composition of claim 1, wherein the liquid carrier is selected from the group consisting of water, C₂ to C₄ alkanols and mixtures thereof.

6. The coating composition of claim 1, wherein the pigment, comprises at least one selected from the group consisting of conductive pigments, fluorescent pigments, opacifying agents, UV absorbing pigments, reflecting pigments and infrared absorbing pigments.

7. The coating composition of claim 1, wherein the pigment is electrically conductive providing the fibers with electrical conductivity.

8. The coating composition of claim 1, wherein the pigment is a reflective material selected from glass beads, mica or a mixture thereof.

9. The coating composition, according to claim 1, wherein the microfiber further comprises a quaternary ammonium surfactant adhered at the surface of the microfibers.

10. The coating composition of claim 1, wherein the pigment is present in the microfibers in an amount in the range of 10% w/w to 100% w/w based on the weight of the polymer component of the microfibers.

11. The coating composition of claim 1, wherein the microfiber composition comprises at least one polymer of melting point 60° C. to 140° C. in an amount of from 40% to 99% by weight.

12. The coating composition of claim 1, wherein the microfibers are of average diameter 0.1 to 10 microns, and aspect ratio of at least 2.

13. The coating composition of claim 1, wherein the microfibers comprise an ethylene-(meth)acrylic acid copolymer having a melting point in the range of from 60° C. to 140° C. in an amount in the range of from 20% to 90% and pigment present in an amount of from 10% to 50% by weight of the microfibers.

14. A coating composition of claim 13 wherein the pigment is a reflective material selected from glass beads and mica.

15. A method of coating at least part of a flexible substrate comprising applying to the substrate a coating composition according to claim 1 and heating the coated substrate to a temperature in the range of 80° C. to 140° C.

16. The method of claim 15 wherein the microfibers comprise a thermoplastic polymer having a melting point in the range of from 80° C. to 140° C. and the coating composition is cured by subjecting the coated substrate to a temperature above the melting point of the polymer and in the range of from 100° C. to 140° C.

17. The method of claim 15, wherein the substrate is selected from the group consisting of fabric, leather, metals, cellulosic material and polymer film.

18. The method according to claim 17, wherein the substrate is a fabric.

19. The method of claim 18, wherein the coating is shear thinning and is applied by screen printing.

20. The method of claim 18, wherein the fabric comprises synthetic fibers selected from polyester, polyolefin, polyamide, multifiber yarn comprising at least one of polyester, polyamide and polyolefin fibers.
